(19) United States
(12) Patent Application Publication
(10) Pub. No.: US 2005/0240450 A1
(43) Pub. Date: Oct. 27, 2005

(54) Insurance policy with limit on number of claims indemnified

(76) Inventor: David A. Martin, Bentleyville, OH (US)

Correspondence Address: BROUSE MCDOWELL, 388 SOUTH MAIN STREET, SUITE 500, AKRON, OH, 44311-4407, US

(21) Appl. No.: 11/114,805

(22) Filed: Apr. 26, 2005

Related U.S. Application Data
(60) Provisional application No. 60/565,506, filed on Apr. 26, 2004.
(60) Provisional application No. 60/566,504, filed on Apr. 29, 2004.

(51) Int. Cl. G06F 17/60

(52) U.S. Cl. 705/4

(57) ABSTRACT

A new and improved insurance policy with a limit on the number of claims indemnified is herein disclosed. An insurance policy includes a limitation clause, wherein the policy is limited if more than a specified number of claims occur, incidents reported, or losses paid, wherein at least one limitation in the limitation clause is chosen from the group comprising: decreasing payment of defense costs, decreasing payment of loss amount, decreasing payment of both defense costs and payment of loss amount, and terminating the policy. An insurance policy includes a first coverage amount and at least a second coverage amount, the at least a second coverage amount being different than the first coverage amount, wherein the coverage amounts are not per claim coverage amounts. A re-insurance policy includes a coverage amount, the coverage amount insuring an associated primary policy provider against losses for at least a first claim subsequent to a specified number of claims.

This application claims priority to provisional patent applications with Ser. No. 60/565,506, filed Apr. 26, 2004, entitled Insurance Policy With Limit On Number Of Claims Indemnified, and Ser. No. 60/566,504, filed Apr. 29, 2004, entitled Insurance Policy With Limit On Number Of Claims Indemnified.

### I. BACKGROUND OF THE INVENTION

A. Field of the Invention

This invention relates to the art of insurance, and more particularly to limiting the number of claims indemnified by an insurance provider.

B. Description of the Related Art

Insurance companies in most lines of insurance take into account two broad categories of analysis in determining their rates and experience: Frequency and Severity. Simply defined, “Frequency” is the number of claims, while “Severity” deals with how bad or severe the claims are (most commonly measured financially). Frequency: number of claims. Severity: intensity of the claims. The effect of an earthquake or hurricane on a given home and auto insurer can easily illustrate these concepts: the number of insured homes and autos damaged in the natural disaster would represent “Frequency,” while the amount of damage and corresponding financial loss to each insured home and auto (as well as the collective amount of damage and financial loss) would represent “Severity.”

All insurers in the property and casualty field limit their liability by placing “limits” on the dollar amount of indemnification that they will provide to their policyholders. This strategy of placing limits on indemnification amounts is designed to keep an insurers' exposure-to-loss within reasonable confines. Every insurance policy is designed to indemnify the beneficiary of the policy against loss, up to certain financial limits.

Except in cases where one event is being insured, such as a given space shuttle mission, no policy has been designed that places limits on the number of claims (either in total or of a specific type or nature) that will be indemnified in a given policy period. For example, medical professional liability policies all place limits on the financial amount of indemnification provided under the terms of the policy. They do NOT place a limit on the number of malpractice lawsuits that they will respond to and cover. Thus coverage is not exhausted until the financial limits of indemnification have been exhausted.

The present invention provides a new and improved method for limiting an insurance provider's exposure, and overcomes certain difficulties inherent in the related inventions while providing better overall results.

II. Definitions

To assist the reader in understanding the description of this invention, the definitions of the following terms should be noted.
Alien insurer—an insurance provider that has its principal place of business outside the United States and is not licensed in the particular jurisdiction of interest.
Captive insurance company—an insurance provider that is owned and/or controlled by the entity that is being insured.
Category of exposure—a specific area of liability or loss exposure.
Claim—any demand for money or services made by, or against, a policyholder
Coverage amount—the total monetary value that an insurance provider will pay to, or on behalf of, a policyholder for each incident.
Deductible—The amount of loss paid by the policyholder before the insurance policy benefits become payable.
Domestic insurer—an insurance provider that has its principal place of business in the United States and is licensed in the particular jurisdiction of interest.
Foreign insurer—an insurance provider that has its principal place of business in the United States and is not licensed in the particular jurisdiction of interest.
Incident—any event which a policyholder should reasonably believe could become a claim.
Insurance jurisdiction—a region under the regulatory control of an insurance regulatory agency.
Insurance payment amount—the total monetary value that an insurance provider will pay to, or on behalf of, a policyholder independent of the number of claims and/or incidents covered.
Insurance policy—any agreement or indemnification for losses by an insurance provider or a re-insurance provider. In this invention, the definition of “insurance policy” specifically excludes one-time planned events, such as the space shuttle launch or the 2004 Olympics in Athens.
Loss Amount—the monetary value to restore the party suffering a loss, in whole or in part, by payment, repair, or replacement.
Property and casualty insurance—an insurance policy providing coverage for loss and/or damage to personal or real property, life, or person.
Reinsurance—(1) A contract of indemnity against liability by which the insurance provider procures another insurance to insure against loss or liability by reason of the original insurance; (2) Insurance by one insurance provider of all or part of a risk accepted by it with another insurance provider which agrees to reimburse the insurance provider for the portion of the claim insured.

### III. SUMMARY OF THE INVENTION

In accordance with one aspect of the present invention, an insurance policy includes a limitation clause, wherein the policy is limited if more than a specified number of claims occur, wherein at least one limitation in the limitation clause is chosen from the group comprising: decreasing payment of defense costs, decreasing payment of loss amount, decreasing payment of both defense costs and payment of loss amount, and terminating the policy.

In accordance with another aspect of the present invention, the policy is limited by excluding payment of costs to defend a claim.

In accordance with another aspect of the present invention, the policy is limited by excluding payment of the loss amount.

In accordance with another aspect of the present invention, the policy is terminated if more than a specified number of claims occur.

In accordance with another aspect of the present invention, the policy is limited if more than one claim occurs within a specified time period.

In accordance with another aspect of the present invention, the amount of the defense costs paid decreases with each subsequent claim.

In accordance with another aspect of the present invention, between approximately 99% and approximately 75% of the defense costs are paid for each subsequent claim.

In accordance with another aspect of the present invention, between approximately 99% and approximately 75% of the defense costs are paid for a second claim and between approximately 75% and approximately 0% of the defense costs are paid for a third claim.

In accordance with another aspect of the present invention, between approximately 99% and approximately 75% of the defense costs are paid for the second claim, between approximately 75% and approximately 50% of the defense costs are paid for the third claim, between approximately 50% and approximately 25% of the defense costs are paid for a fourth claim, and between approximately 25% and approximately 0% of the defense costs are paid for a fifth claim.

In accordance with another aspect of the present invention, the amount of the loss amount paid decreases with each subsequent claim.

In accordance with another aspect of the present invention, between approximately 99% and approximately 75% of the loss amount is paid for each subsequent claim.

In accordance with another aspect of the present invention, between approximately 99% and approximately 75% of the loss amount is paid for a second claim and between approximately 75% and approximately 0% of the loss amount is paid for a third claim.

In accordance with another aspect of the present invention, between approximately 99% and approximately 75% of the loss amount is paid for the second claim, between approximately 75% and approximately 50% of the loss amount is paid for the third claim, between approximately 50% and approximately 25% of the loss amount is paid for a fourth claim, and between approximately 25% and approximately 0% of the loss amount is paid for a fifth claim.

In accordance with another aspect of the present invention, the amount of the defense costs and the amount of loss amount paid decreases with each subsequent claim.

In accordance with another aspect of the present invention, between approximately 99% and approximately 75% of the loss amount is paid and between 99% and approximately 75% of the defense costs is paid for each subsequent claim.

In accordance with another aspect of the present invention, between approximately 99% and approximately 75% of the loss amount is paid for a second claim, between approximately 75% and approximately 0% of the loss amount is paid for a third claim, between 99% and approximately 75% of the defense costs is paid for the second claim, and between 75% and approximately 0% of the defense costs is paid for third claim.

In accordance with another aspect of the present invention, between approximately 99% and approximately 75% of the loss amount is paid for the second claim, between approximately 75% and approximately 50% of the loss amount is paid for the third claim, between approximately 50% and approximately 25% of the loss amount is paid for a fourth claim, between approximately 25% and approximately 0% of the loss amount is paid for a fifth claim, between 99% and approximately 75% of the defense costs is paid for the second claim, between 75% and approximately 50% of the defense costs is paid for the third claim, between 50% and approximately 25% of the defense costs is paid for the fourth claim, and between 25% and approximately 0% of the defense costs is paid for the fifth claim.

In accordance with another aspect of the present invention, the policy is limited if more than two claims occur.

In accordance with another aspect of the present invention, an insurance policy includes a limitation clause wherein the policy is limited if more than a specified number of incidents are reported, wherein at least one limitation in the limitation clause is chosen from the group comprising: decreasing payment of defense costs, decreasing payment of loss amount, decreasing payment of both defense costs and payment of loss amount, and terminating the policy.

In accordance with another aspect of the present invention, the policy is limited if more than one incident is reported within a specified time period.

In accordance with another aspect of the present invention, the policy is limited if more than two incidents are reported.

In accordance with another aspect of the present invention, the policy is terminated if more than a specified number of incidents are reported.

In accordance with another aspect of the present invention, an insurance policy includes a first insurance payment amount and at least a second insurance payment amount, the at least a second payment amount being different than the first payment amount.

In accordance with another aspect of the present invention, the at least a second payment amount comprises at least a third payment amount, the at least a third payment amount being different than the first and second payment amounts.

In accordance with another aspect of the present invention, the first, second, and third payment amounts are each payment amounts for a specified number of claims.

In accordance with another aspect of the present invention, the insurance payment amounts are for a specified category of exposure. The categories of exposure can be, but is not limited to, bodily injury, property damage, wage loss, emotional distress, etc.

In accordance with another aspect of the present invention, a re-insurance policy includes a coverage amount, the coverage amount insuring an associated primary policy provider against losses for at least a first claim subsequent to a specified number of claims.

In accordance with another aspect of the present invention, the coverage amount is for at least the first claim subsequent to the specified number of claims, within a specified time period.

In accordance with another aspect of the present invention, the primary policy has a first coverage amount for a specified number of claims and at least a second coverage amount, the at least a second coverage amount being less than the first coverage amount, the re-insurance policy comprising a third coverage amount, the third coverage amount being the difference between the first coverage amount and the second coverage amount.

In accordance with another aspect of the present invention, an insurance policy includes a limitation clause, wherein the policy is limited if more than a specified number of losses are paid, wherein at least one limitation in the limitation clause is chosen from the group comprising: decreasing payment of defense costs, decreasing payment of loss amount, decreasing payment of both defense costs and payment of loss amount, and terminating the policy.

In accordance with another aspect of the present invention, the policy is terminated if more than a specified number of losses are paid.

In accordance with another aspect of the present invention, the policy is limited if more than one loss is paid within a specified time period.

In accordance with another aspect of the present invention, the amount of the defense costs paid decreases with each subsequent loss paid.

In accordance with another aspect of the present invention, between approximately 99% and approximately 75% of the defense costs are paid for each subsequent loss paid.

In accordance with another aspect of the present invention, between approximately 99% and approximately 75% of the defense costs are paid for a second loss paid and between approximately 75% and approximately 0% of the defense costs are paid for a third loss paid.

In accordance with another aspect of the present invention, between approximately 99% and approximately 75% of the defense costs are paid for the second loss paid, between approximately 75% and approximately 50% of the defense costs are paid for the third loss paid, between approximately 50% and approximately 25% of the defense costs are paid for a fourth loss paid, and between approximately 25% and approximately 0% of the defense costs are paid for a fifth loss paid.

In accordance with another aspect of the present invention, the amount of the loss amount paid decreases with each subsequent loss paid.

In accordance with another aspect of the present invention, between approximately 99% and approximately 75% of the loss amount is paid for each subsequent loss paid.

In accordance with another aspect of the present invention, between approximately 99% and approximately 75% of the loss amount is paid for a second loss paid and between approximately 75% and approximately 0% of the loss amount is paid for a third loss paid.

In accordance with another aspect of the present invention, between approximately 99% and approximately 75% of the loss amount is paid for the second loss paid, between approximately 75% and approximately 50% of the loss amount is paid for the third loss paid, between approximately 50% and approximately 25% of the loss amount is paid for a fourth loss paid, and between approximately 25% and approximately 0% of the loss amount is paid for a fifth loss paid.

In accordance with another aspect of the present invention, the amount of the defense costs and the amount of loss amount paid decreases with each subsequent loss paid.

Still other benefits and advantages of the invention will become apparent to those skilled in the art upon a reading and understanding of the following detailed specification.

### IV. DESCRIPTION OF THE INVENTION

The present invention involves an insurance policy of the type designed to insure multiple possible insurable events, and which limits the number of insurable events to be indemnified by the policy. For example, an insurance policy that indemnifies a physician for loss due to medical malpractice, but which will only respond to the first two, three, four, etc. claims that are made. By design, this type of policy will protect the insurance company from too many losses due to a chronically negligent physician. If the physician is sued too many times, the insurance policy ceases to indemnify them after a predetermined number of claims have been made. The policy could track the claims on a first-reported basis, on a date-of-incident basis, or on a date-loss-paid basis. Another aspect of the present invention involves a policy as discussed in this paragraph, which is combined with limits on the amount of indemnity available financially on a per-incident, per-claim, per loss, and/or policy-aggregate basis.

### EXAMPLE 1

An insurance policy with $1,000,000 of coverage per claim, with a total aggregate coverage of $3,000,000 is underwritten for a physician. The insurance policy contains a clause wherein the policy is terminated after three claims occur. For example, if the physician has a claim for $250,000, a claim for $200,000, and a claim for $500,000, the policy will be terminated. Even though, in this example, the monetary limits of the policy have not been exhausted, the policy is terminated because of the number of claims.

In another embodiment of this invention, the policy contains a limitation clause, wherein the policy is limited after a specified number of claims occur. The policy is limited either by the amount of defense costs paid, the loss amount paid, or the policy is terminated.

### EXAMPLE 2

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the defense costs will be covered for subsequent claims (subject to the $1,000,000/$3,000,000 maximums), with the total loss amount being paid (subject to the $1,000,000/$3,000,000 maximums).

### EXAMPLE 3

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the loss amount will be covered for subsequent claims (subject to the $1,000,000/$3,000,000 maximums), with the total defense costs being paid (subject to the $1,000,000/$3,000,000 maximums).

### EXAMPLE 4

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the defense costs will be covered for a second claim (subject to the $1,000,000/$3,000,000 maximums), up to 50% of the defense costs will be covered for a third claim (subject to the $1,000,000/$3,000,000 maximums), with the total loss amount being paid (subject to the $1,000,000/$3,000,000 maximums).

### EXAMPLE 5

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the loss amount will be covered for a second claim (subject to the $1,000,000/$3,000,000 maximums), up to 50% of the loss amount will be covered for a third claim (subject to the $1,000,000/$3,000,000 maximums), with the total defense costs being paid (subject to the $1,000,000/$3,000,000 maximums).

### EXAMPLE 6

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the defense costs will be covered for a second claim (subject to the $1,000,000/$3,000,000 maximums), up to 50% of the defense costs will be covered for a third claim (subject to the $1,000,000/$3,000,000 maximums), up to 25% of the defense costs will be covered for a fourth claim (subject to the $1,000,000/$3,000,000 maximums), with the total loss amount being paid (subject to the $1,000,000/$3,000,000 maximums).

### EXAMPLE 7

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the loss amount will be covered for a second claim (subject to the $1,000,000/$3,000,000 maximums), up to 50% of the loss amount will be covered for a third claim (subject to the $1,000,000/$3,000,000 maximums), up to 25% of the loss amount will be covered for a fourth claim (subject to the $1,000,000/$3,000,000 maximums), with the total defense costs being paid (subject to the $1,000,000/$3,000,000 maximums).

### EXAMPLE 8

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the loss amount will be covered (subject to the $1,000,000/$3,000,000 maximums), and up to 75% of the defense costs will be paid (subject to the $1,000,000/$3,000,000 maximums) for subsequent claims.

### EXAMPLE 9

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the loss amount will be covered (subject to the $1,000,000/$3,000,000 maximums), and up to 75% of the defense costs will be paid (subject to the $1,000,000/$3,000,000 maximums) for a second claim; up to 50% of the loss amount will be covered (subject to the $1,000,000/$3,000,000 maximums), and up to 50% of the defense costs will be paid (subject to the $1,000,000/$3,000,000 maximums) for a third claim.

### EXAMPLE 10

An insurance policy with $1,000,000 of coverage per claim, with a total aggregate coverage of $3,000,000 is underwritten for a physician. The insurance policy contains a limitation clause wherein the policy is limited gradually as subsequent claims occur. After the first claim, up to 75% of the loss amount will be covered (subject to the $1,000,000/$3,000,000 maximums), and up to 75% of the defense costs will be paid (subject to the $1,000,000/$3,000,000 maximums) for a second claim; up to 50% of the loss amount will be covered (subject to the $1,000,000/$3,000,000 maximums), and up to 50% of the defense costs will be paid (subject to the $1,000,000/$3,000,000 maximums) for a third claim; up to 25% of the loss amount will be covered (subject to the $1,000,000/$3,000,000 maximums), and up to 25% of the defense costs will be paid (subject to the $1,000,000/$3,000,000 maximums) for a fourth claim.

The above examples are merely embodiments of the present invention, and are not intended to limit the invention in any manner. It is to be understood that any type of insurance policy can be used, any percentages, and any combination of number of claims, defense costs, and loss amounts paid, can be used, as long as chosen using sound business judgment. It is also to be understood that the above embodiments can include limitations based upon the number of incidents, as well as the number of losses paid. It is also to be understood that the limitations and/or termination may apply whether or not claims are paid to, or on behalf, of the policyholder.

In another embodiment of this invention, the policy could be written so that the policy is limited to a certain number of claims within a specified time period, such as twelve months. In this embodiment, the policyholder may have a higher number of claims than in the previous embodiment, as long as the claims are spread out over a longer period of time. For example, a policy could be written to limit, or terminate, the policy if more than two claims occur within any twelve month period. It is to be understood that the specific time limit to be chosen, as well as the number of claims, incidences, or losses paid, is not intended to limit the invention in any manner.

Another aspect of the present invention involves a reinsurance treaty or facultative agreement, in which a re-insurer agrees to indemnify the primary insurer against all losses for claims in excess of a predetermined number of claims. Another aspect of the present invention involves a reinsurance treaty or facultative reinsurance agreement as discussed in this paragraph, which is combined with limits on the amount of indemnity available financially on a per-incident, per-claim, per loss, and/or policy-aggregate basis. For example, the re-insurance policy could be written to insure the primary insurer against all losses for any claims after the second claim. It is to be understood that the number of claims is not intended to limit the invention.

In another embodiment of the present invention, the amounts of indemnification, by the insurer, changes with subsequent claims. Varying limits of coverage would be offered for claims over a certain number of claims. Another variation of this embodiment could encompass the varying limits of coverage beginning after the first claim or in any order.

As an example of the above embodiment, the insurance company provides a policy that indemnifies the insured for up to $1,000,000 for the first claim, up to $500,000 for the second and third claims, and up to $100,000 for the fourth claim. Another example would be up to $1,000,000 for the first three claims and up to $500,000 for any subsequent claims. The examples are not intended to limit the invention in any manner. It is contemplated that any arrangement of the varying limits of coverage is contemplated by this invention, as long as chosen using sound business and insurance judgment. It is also contemplated that this embodiment could be combined with the previous embodiment, wherein the total number of claims allowed is limited to a certain number, and the limits of coverage vary with the subsequent claims.

The present invention provides for a policy that could cease to indemnify a policyholder prior to exhausting the financial indemnification limits of coverage, in the event that the number of claims indemnified by the policy/insurer is first exhausted. For example, in one embodiment, the policy provides for coverage of $1,000,000, but is limited to three claims. So, even if the first claim is for $150,000, the second claim is for $200,000, and third claim is for $400,000, the policy is terminated, even though the policyholder did not reach the maximum amount of coverage allowed by the policy.

In another embodiment of the present invention, an insurance policy is provided that includes multiple different insurance payment amounts. For example, a policy contains first payment amount of $1,000,000, a second payment amount of $500,000, and a third payment amount of $250,000. The payment amounts can be used for any number of claims, and used in any order that is desired by the insured. If two claims come in for a total of $200,000, the third payment amount can be used to pay those, and the third payment amount would have $50,000 remaining. If the next claim was for $300,000, either the first or payment coverage amount would need to be used to cover the $300,000. Variations of this embodiment could include each payment amount covering one claim only, regardless of the amount paid, or each payment amount could be for a specified number of claims.

### EXAMPLE 11

A policy is underwritten having three payment amounts, such as $1,000,000, $500,000, and $250,000. Each payment amount covers only one claim. A first claim comes in for $175,000, and the third payment amount is used. The remaining $75,000 of the third payment amount cannot be used. A second claim would have to use either the $1,000,000 or $500,000 regardless of the amount.

### EXAMPLE 12

A policy is underwritten having three payment amounts, such as $1,000,000, $500,000, and $250,000. The first payment amount covers up to four (4) claims, the second payment amount covers up to three (3) claims, and the third payment amount covers up to two (2) claims. A first claim comes in for $175,000, and the third payment amount is used. The third payment amount can cover one more claim for up to $75,000. A second claim comes in for $800,000, and the first payment amount is used. The first payment amount can cover three more claims for up to a total of $200,000.

It is to be understood that the above embodiment can use any payment amounts, any number of payment amounts, and any variation of claims, incidences, or losses paid, as long as chosen using sound business judgment.

It is to be understood that the present invention can encompass a claims made tail policy within the above embodiments.

It is also to be understood that the terms first, second, third, etc. as they apply to claims, incidences, losses paid, and/or coverage amounts do not necessarily refer to chronological order.

It is also to be understood that the above percentages for the defense costs and the loss amounts paid can be, but are not limited to, the following: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100.

The invention has been described with reference to several embodiments. Obviously, modifications and alterations will occur to others upon a reading and understanding of the specification. It is intended by applicant to include all such modifications and alterations insofar as they come within the scope of the appended claims or the equivalents thereof.

Having thus described the invention, it is now claimed:

1. An insurance policy comprising:
a limitation clause, wherein the policy is limited if more than a specified number of claims occur, wherein at least one limitation in the limitation clause is chosen from the group comprising: decreasing payment of defense costs, decreasing payment of loss amount, decreasing payment of both defense costs and payment of loss amount, and terminating the policy.

2. The insurance policy of claim 1, wherein the policy is limited by excluding payment of costs to defend a claim.

3. The insurance policy of claim 1, wherein the policy is limited by excluding payment of the loss amount.

4. The insurance policy of claim 1, wherein the policy is terminated if more than a specified number of claims occur.

5. The insurance policy of claim 1, wherein the policy is limited if more than one claim occurs within a specified time period.

6. The insurance policy of claim 5, wherein the amount of the defense costs paid decreases with each subsequent claim.

7. The insurance policy of claim 6, wherein between approximately 99% and approximately 75% of the defense costs are paid for each subsequent claim.

8. The insurance policy of claim 7, wherein between approximately 99% and approximately 75% of the defense costs are paid for a second claim and between approximately 75% and approximately 0% of the defense costs are paid for a third claim.

9. The insurance policy of claim 8, wherein between approximately 99% and approximately 75% of the defense costs are paid for the second claim, between approximately 75% and approximately 50% of the defense costs are paid for the third claim, between approximately 50% and approximately 25% of the defense costs are paid for a fourth claim, and between approximately 25% and approximately 0% of the defense costs are paid for a fifth claim.

10. The insurance policy of claim 5, wherein the amount of the loss amount paid decreases with each subsequent claim.

11. The insurance policy of claim 10, wherein between approximately 99% and approximately 75% of the loss amount is paid for each subsequent claim.

12. The insurance policy of claim 11, wherein between approximately 99% and approximately 75% of the loss amount is paid for a second claim and between approximately 75% and approximately 0% of the loss amount is paid for a third claim.

13. The insurance policy of claim 12, wherein between approximately 99% and approximately 75% of the loss amount is paid for the second claim, between approximately 75% and approximately 50% of the loss amount is paid for the third claim, between approximately 50% and approximately 25% of the loss amount is paid for a fourth claim, and between approximately 25% and approximately 0% of the loss amount is paid for a fifth claim.

14. The insurance policy of claim 5, wherein the amount of the defense costs and the amount of loss amount paid decreases with each subsequent claim.

15. The insurance policy of claim 14, wherein between approximately 99% and approximately 75% of the loss amount is paid and between 99% and approximately 75% of the defense costs is paid for each subsequent claim.

16. The insurance policy of claim 15, wherein
between approximately 99% and approximately 75% of the loss amount is paid for a second claim;
between approximately 75% and approximately 0% of the loss amount is paid for a third claim;
between 99% and approximately 75% of the defense costs is paid for the second claim; and,
between 75% and approximately 0% of the defense costs is paid for third claim.

17. The insurance policy of claim 16, wherein
between approximately 99% and approximately 75% of the loss amount is paid for the second claim;
between approximately 75% and approximately 50% of the loss amount is paid for the third claim;
between approximately 50% and approximately 25% of the loss amount is paid for a fourth claim;
between approximately 25% and approximately 0% of the loss amount is paid for a fifth claim;
between 99% and approximately 75% of the defense costs is paid for the second claim;
between 75% and approximately 50% of the defense costs is paid for the third claim;
between 50% and approximately 25% of the defense costs is paid for the fourth claim; and,
between 25% and approximately 0% of the defense costs is paid for the fifth claim.

18. The insurance policy of claim 1, wherein the policy is limited if more than two claims occur.

19. An insurance policy comprising:
a limitation clause wherein the policy is limited if more than a specified number of incidents are reported, wherein at least one limitation in the limitation clause is chosen from the group comprising: decreasing payment of defense costs, decreasing payment of loss amount, decreasing payment of both defense costs and payment of loss amount, and terminating the policy.

20. The insurance policy of claim 19, wherein the policy is limited if more than one incident is reported within a specified time period.

21. The insurance policy of claim 19, wherein the policy is limited if more than two incidents are reported.

22. The insurance policy of claim 19, wherein the policy is terminated if more than a specified number of incidents are reported.

23. An insurance policy comprising:
a first insurance payment amount; and,
at least a second insurance payment amount, the at least a second payment amount being different than the first payment amount.

24. The insurance policy of claim 23, wherein the insurance payment amounts are for a specified category of exposure.

25. The insurance policy of claim 23, wherein the at least a second payment amount comprises:
at least a third insurance payment amount, the at least a third payment amount being different than the first and second payment amounts.

26. The insurance policy of claim 25, wherein the first, second, and third payment amounts are each payment amounts for a specified number of claims.

27. The insurance policy of claim 23, wherein the policy further comprises:
a limitation clause, wherein the policy is limited if more than a specified number of claims occur, wherein at least one limitation in the limitation clause is chosen from the group comprising: decreasing payment of defense costs, decreasing payment of loss amount, decreasing payment of both defense costs and payment of loss amount, and terminating the policy.

28. The insurance policy of claim 27, wherein the policy is limited if more than the specified number of claims occur within a specified time period.

29. The insurance policy of claim 23, wherein the policy further comprises:
a limitation clause, wherein the policy is limited if more than a specified number of incidents are reported, wherein at least one limitation in the limitation clause is chosen from the group comprising: decreasing payment of defense costs, decreasing payment of loss amount, decreasing payment of both defense costs and payment of loss amount, and terminating the policy.

30. The insurance policy of claim 29, wherein the policy is limited if more than the specified number of incidents are reported within a specified time period.

31. A re-insurance policy comprising:
a coverage amount, the coverage amount insuring an associated primary policy provider against losses for at least a first claim subsequent to a specified number of claims.

32. The policy of claim 31, wherein the coverage amount is for at least the first claim subsequent to the specified number of claims, within a specified time period.

33. The policy of claim 31, wherein the primary policy has a first coverage amount for a specified number of claims and at least a second coverage amount, the at least a second coverage amount being less than the first coverage amount, the re-insurance policy comprising:
a third coverage amount, the third coverage amount being the difference between the first coverage amount and the second coverage amount.

34. An insurance policy comprising:
a limitation clause, wherein the policy is limited if more than a specified number of losses are paid, wherein at least one limitation in the limitation clause is chosen from the group comprising: decreasing payment of defense costs, decreasing payment of loss amount, decreasing payment of both defense costs and payment of loss amount, and terminating the policy.

35. The insurance policy of claim 34, wherein the policy is limited by excluding payment of costs to defend a claim.

36. The insurance policy of claim 34, wherein the policy is limited by excluding payment of the loss amount.

37. The insurance policy of claim 34, wherein the policy is terminated if more than a specified number of losses are paid.

38. The insurance policy of claim 34, wherein the policy is limited if more than one loss is paid within a specified time period.

39. The insurance policy of claim 38, wherein the amount of the defense costs paid decreases with each subsequent loss paid.

40. The insurance policy of claim 39, wherein between approximately 99% and approximately 75% of the defense costs are paid for each subsequent loss paid.

41. The insurance policy of claim 40, wherein between approximately 99% and approximately 75% of the defense costs are paid for a second loss paid and between approximately 75% and approximately 0% of the defense costs are paid for a third loss paid.

42. The insurance policy of claim 41, wherein between approximately 99% and approximately 75% of the defense costs are paid for the second loss paid, between approximately 75% and approximately 50% of the defense costs are paid for the third loss paid, between approximately 50% and approximately 25% of the defense costs are paid for a fourth loss paid, and between approximately 25% and approximately 0% of the defense costs are paid for a fifth loss paid.

43. The insurance policy of claim 38, wherein the amount of the loss amount paid decreases with each subsequent loss paid.

44. The insurance policy of claim 43, wherein between approximately 99% and approximately 75% of the loss amount is paid for each subsequent loss paid.

45. The insurance policy of claim 44, wherein between approximately 99% and approximately 75% of the loss amount is paid for a second loss paid and between approximately 75% and approximately 0% of the loss amount is paid for a third loss paid.

46. The insurance policy of claim 45, wherein between approximately 99% and approximately 75% of the loss amount is paid for the second loss paid, between approximately 75% and approximately 50% of the loss amount is paid for the third loss paid, between approximately 50% and approximately 25% of the loss amount is paid for a fourth loss paid, and between approximately 25% and approximately 0% of the loss amount is paid for a fifth loss paid.

47. The insurance policy of claim 38, wherein the amount of the defense costs and the amount of loss amount paid decreases with each subsequent loss paid.
